(19) United States
(12) Patent Application Publication
(10) Pub. No.: US 2023/0141886 A1
(43) Pub. Date: May 11, 2023

(54) METHOD FOR ASSESSING HAZARD ON FLOOD SENSITIVITY BASED ON ENSEMBLE LEARNING

(71) Applicant: HOHAI UNIVERSITY, Nanjing (CN)

(72) Inventors: Hexuan HU, Nanjing (CN); Qiang HU, Nanjing (CN); Ye ZHANG, Nanjing (CN); Zhenyun HU, Nanjing (CN)

(21) Appl. No.: 17/995,018

(22) PCT Filed: Mar. 2, 2022
(86) PCT No.: PCT/CN2022/078765

§ 371 Date: Sep. 29, 2022

(30) Foreign Application Priority Data
Mar. 2, 2021 (CN) 202110231150.3

(51) Int. Cl. G06N 20/20; G06F 18/21; G06F 18/214; G06F 18/2113

(52) U.S. Cl. CPC G06N 20/20; G06F 18/214; G06F 18/217; G06F 18/2113

(57) ABSTRACT

A method for assessing a hazard on flood sensitivity based on an ensemble learning includes collecting such data as topography, hydrometeorology, soil vegetation in a research region as feature data, and standardizing the feature data; extracting the historical inundation points and non-inundation points in the research basin according to historical water level data and remote sensing data; selecting an optimal feature subset by using Laplace scores. The method includes dividing sample points into a training set and a testing set and training the ensemble learning model; and calculating the hazard on the flood sensitivity for the whole basin by using the trained model to generate a grade distribution map of the hazard on the flood sensitivity in the basin. In the present disclosure, each of the feature data in the research region is taken as an input, the ensemble learning model improves accuracy for assessing the flood in the basin.

### TEAHNICAL FIELD

The present disclosure relates to the technical field of flood disaster hazard assessment, in particular to a method for assessing a hazard on flood sensitivity based on an ensemble learning.

### BACKGROUND

Flood disaster is a kind of natural disaster with great destructive, sudden and high frequency. China is one of the countries with the most frequent flood disasters, a large number of economic losses and casualties will be caused due to the flood disasters every year, and therefore, a research in the field of assessing the hazard on the flood sensitivity is of great significance. The assessment for the hazard on the flood sensitivity is a comprehensive evaluation on the natural and social attributes of the regional flood disasters, aiming to grasp a spatial distribution and an occurrence law of the flood hazard more accurately. The assessment for the hazard on flood sensitivity is an extremely complex process, the assessment process involves multiple evaluation indicators, and therefore, the assessment for the hazard on the flood sensitivity has permanently been one of the difficulties and hot spots in disaster research in China and abroad.

With the development of artificial intelligence technology, the application of machine learning algorithms to target evaluation has become a trend, but there are still some deficiencies. For example, in the prior art, Pat. Application CN106651211A discloses a method for assessing hazards on regional flood disasters at different scales, which uses a coupled model of AHP analytic hierarchy process and entropy weight method to assess the hazard value for the flood disaster in the research region and divide the hazard grade. However, this method needs to collect a large amount of natural and social data as inputs, once the amount of data is less or the quality of data is not high, relatively larger errors will be caused in the results. Besides, this method requires higher professional knowledge for operators, the determinations by the operators will be confused when the number of flood influencing factors is large, thereby affecting the assessment results.

The random forest-based flood hazard assessment method proposed by Lai Chengguang et al. in January 2015 in “Journal of Hydraulic Engineering”, Vol. 46, No. 1, page 58, simplifies the hazard assessment process, but has the problems of relatively longer running time and low accuracy.

To sum up, the existing methods for assessing hazards on the flood sensitivities have the following deficiencies: (1) A large amount of natural and social data are required and the workload of the data collection is huge. (2) The requirements for the professional knowledge of the operators are relatively higher. (3) The running time is long and the accuracy is relatively lower.

### SUMMARY

The objectives of the present disclosure are to eliminate the deficiencies of the prior art and provide a method for assessing a hazard on flood sensitivity based on an ensemble learning, which can effectively establish a model for assessing the hazard on the flood disaster and provides flood prevention and mitigation measures for meteorological departments and relevant local governments to solve the flood disasters. The method avoids a large number of manual data collections, and has a high efficiency, is convenient to operate, has short operation running time and high accuracy.

In order to solve the above technical problems, the following technical solutions are adopted in the present disclosure.

A method for assessing a hazard on flood sensitivity based on an ensemble learning includes the following steps.

In Step one, initial data of sample points are collected and sorted, that is, a position map of a blood in a basin is drawn by using literature materials and surveying on site, and a spatial database related to the flood is created; regulating factors are selected through data obtained from the literature materials and the survey on site; a plurality of the flood regulating factors are selected to conduct a sensitivity analysis, and a spatial database of the factors is established.

In Step two, the collected initial data are cleaned, standardized, and the initial data are assigned to each evaluation unit, the initial data are converted into a raster data storage format, and a projection conversion and a resampling operation are performed on all of the data; historical flow data are acquired from a corresponding hydrological station for each research region, a date for each year on which a flood flow crest value occurs is retrieved, and MODIS images corresponding to the date are selected to reflect an inundation status during the flood; the inundation ranges reflected by the plurality of images corresponding to the flow crest value is superposed to generate a combined maximum inundation range map as an inundation range map, namely a maximum inundation range, corresponding to the flow crest value; N flood inundation sample points are randomly selected within the maximum inundation range, and N non-flood inundation sample points are randomly selected within the non-maximum flood inundation range to form sample points with a total number of 2N together; the sample points are divided into a training set and a testing set, wherein 70% of the sample points are taken as the training set, and 30% of the sample points are taken as the testing set.

In Step three, Laplace scores are calculated to determine eventual feature subsets; features of the samples in the training set in Step two are scored by using the Laplacian scores to obtain a score for each feature, and k features with the highest scores are eventually taken as selected feature subsets; and the feature subsets are extracted from the sample points with the total number of 2N in Step two to form a new training set and a new testing set.

In Step four, a LightGBM model of the ensemble learning is trained by using the new training set in Step three, and accuracy rates of the LightGBM model of the ensemble learning for the new training set and the new testing set are obtained.

In Step five, the calculation is conducted for the whole basin by using the trained model to obtain a probability value for the hazard on the flood sensitivity in the whole basin.

Further, the plurality of the flood regulating factors in Step one include: atmosphere, evaporation, topography, and river networks; 10 indicators, namely features, for assessing the hazard on the flood sensitivity, including elevations, gradients, curvatures, TWI, SPI, distances from rivers, soil, vegetation, slope directions and rainfalls are proposable from the 4 factors; according to a mechanism of the flood in the basin, the factors are calculated and processed based on an ArcGIS software, and the SPI and the TWI are calculated by using the following formulas:

$$\text{TWI} = L n \left(α / tan β\right)$$

and

$$\text{SPI} = {A}_{s} tan β$$

where α represents a cumulative slope water discharge through one point, Aₛ represents a specific basin area, and tan β represents a gradient angle at the point.

Further, the standardizing process on the initial data in Step two includes the following.

Data cleaning is performed on a sample data set S to remove corrupt and unnecessary data to conduct a correlation verification.

All scale condition factors are classified by using a popular quantile method; each condition factor is converted into a grid spatial database with the size of m*n after the sample data set S is prepared, and a grid map for the basin region is constructed.

Further, the process of calculating the Laplace scores to determine the eventual feature subsets in Step three includes the following.

An adjacency matrix G is constructed for the samples in the training set in Step two: when type (i)=type (j), then Gᵢⱼ =1, otherwise Gᵢⱼ =0, and then it is made that

$${G}_{\text{ij}} = {e}^{- \frac{{\left‖{x}_{i} - {x}_{j}\right‖}^{2}}{t}}$$

for points of Gᵢⱼ =1 in the matrix, where t is a suitable constant.

A thereby obtained matrix is a weight matrix S of the training set, where

$${S}_{i j} = {e}^{- \frac{{\left‖{x}_{i} - {x}_{j}\right‖}^{2}}{t}} .$$

A formula for calculating the Laplace scores is as following:

$${L}_{r} = \frac{\sum {}_{i j} {\left({f}_{r i} - {f}_{r j}\right)}^{2} {S}_{i j}}{V a r \left({f}_{r}\right)}$$

where Lᵣ is a Laplace score for an r-th feature; fᵣᵢ - fᵣⱼ is a difference of the r-th features of an i-th sample and a j-th sample; Sᵢⱼ is a corresponding value in the weight matrix, and Var(fᵣ) is a variance of the r-th feature to all samples.

Further, in Step five, research regions for a flood disaster hazard are divided into five grades: a lower hazard region, a less lower hazard region, a medium hazard region, a higher hazard region and an extremely higher hazard region.

Compared with the prior art, the present disclosure has the following advantages and beneficial effects.

(1) The MODIS images on a date for each year on which a flood flow crest value occurs are extracted by using historical remote sensing technology to reflect the inundation status during the flood process and to generate the maximum inundation range map, which has the advantages of a good intuition and high accuracy, and avoids a large number of manual data collections and greatly improves the efficiency.

(2) The importance of each flood impact factor on the assessment results can be intuitively seen by using the Laplacian score method, and the operators can directly prevent the impact factors that have a higher degree of impact on the results after the overall flood hazard assessment is conducted, which greatly improves the operability compared with traditional manual determination.

(3) Compared with the traditional ensemble learning method, the LightGBM adopted by the present disclosure occupies a less memory, takes less computing time, and has higher accuracy.

### BRIEF DESCRIPTION OF THE DRAWINGS

FIG. 1 illustrates a flow chart of a method according to an embodiment of the present disclosure.

FIG. 2 illustrates a flow chart for calculating Laplace scores according to an embodiment of the present disclosure.

FIG. 3 illustrates a result diagram of a verification method according to an embodiment of the present disclosure.

### DETAILED DESCRIPTION OF THE EMBODIMENTS

The present disclosure provides a method for assessing a hazard on flood sensitivity based on an ensemble learning. The method includes: collecting such data as topography, hydrometeorology, soil vegetation in a research region as feature data, and standardizing the feature data; extracting the historical inundation points and non-inundation points in the research basin according to historical water level data and remote sensing data; selecting an optimal feature subset by using Laplace scores; dividing sample points into a training set and a testing set and training the ensemble learning model; and calculating the hazard on the flood sensitivity for the whole basin by using the trained model to generate a grade distribution map of the hazard on the flood sensitivity in the basin. In the present disclosure, each of the feature data in the research region is taken as an input, a novel ensemble learning model is adopted to improve the accuracy for assessing the hazard on the flood in the basin, and eventually a flood hazard mapping map in the basin is generated to intuitively display the flood hazard status in the research region.

The present disclosure will be further described in detail below in combination with the accompanying drawings.

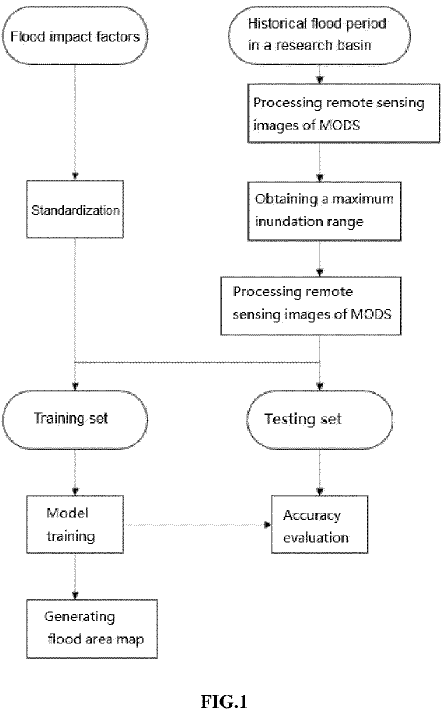

FIG. 1 illustrates a flow chart of a method for assessing a hazard on flood sensitivity based on an ensemble learning provided by the present disclosure.

In Step one, data of sample points are collected and sorted. In order to estimate future flooding events in a region, it is extremely important to analyze its past records. First, a position map of a blood in a basin is drawn by using literature materials and and surveying on site, and a spatial database related to flood is created. Second, regulating factors are selected through data obtained from the literature materials and the survey on site. Finally, a plurality of the flood regulating factors are selected to conduct a sensitivity analysis, and a spatial database of the factors is established.

It is selected to use a historical remote sensing to extract the sample points information on historical floods and select a plurality of the factors related to the occurrence of floods. The factors include atmosphere, evaporation, topography, and river networks. 10 indicators, namely features, for assessing the hazard on the flood sensitivity, including elevations, gradients, curvatures, TWI, SPI, distances from rivers, soil, vegetation, slope directions and rainfall are proposable from the 4 factors. According to a mechanism of the flood in the basin, the factors are calculated and processed based on an ArcGIS software, and the SPI and the TWI are calculated by using the following formulas:

$${\text{TWI=}}^{L n \left(α / tan β\right)}$$

and

$$\text{SPI} {=}^{{A}_{s} tan β}$$

where α represents a cumulative slope water discharge through one point, Aₛ represents a specific basin area, and tan β represents a gradient angle at the point.

In Step two, the collected initial data are cleaned, standardized and the coordinate systems of the initial data are unified. The initial sample data in Step one are standardized and assigned to each evaluation unit, the initial data are converted into a raster data storage format, and all of the data are performed by a projection conversion and a resampling operation. Since flow peaks are the main cause of flood disasters, after historical flow data are acquired from a corresponding hydrological station for each research region, a date for each year on which a flood flow crest value occurs is retrieved, and MODIS images corresponding to the date are selected to reflect an inundation status during the flood. A flood inundation range is extracted by using ENVI5.3, and the inundation ranges reflected by the plurality of images corresponding to the flow crest value is superposed to generate a combined maximum inundation range map as an inundation range map, namely a maximum inundation range, corresponding to the flow crest value. N flood inundation sample points are randomly selected within the maximum inundation range, and N non-flood inundation sample points are randomly selected within the non-maximum flood inundation range to form sample points with a total number of 2N together. The sample points are divided into a training set and a testing set, wherein 70% of the sample points are taken as the training set, and 30% of the sample points are taken as the testing set. In the method for selecting the sample points, historical remote sensing technology are utilized to extract the maximum inundation range map, which has the advantages of a good intuition and high accuracy, and avoids a large number of manual data collections and greatly improves the efficiency.

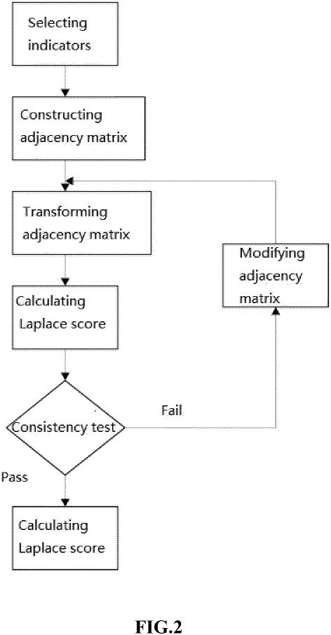

In Step three, Laplace scores are calculated to determine eventual feature subsets: features of the samples in the training set in Step two are scored by using the Laplace scores to obtain a score for each feature, and k features with the highest scores are eventually taken as selected feature subsets.The feature subsets are extracted from the sample points with the total number of 2N in Step two to form a new training set and a new testing set. As illustrated in FIG. 2, FIG. 2 illustrates a flow chart for calculating Laplacian scores according to an embodiment of the present disclosure.

The method specifically includes as follows: An adjacency matrix G is constructed for the samples in the training set in Step two (when type (i) = type (j), Gᵢⱼ =1, otherwise Gᵢⱼ=0), and then it is made that

$${G}_{\text{ij}} = {e}^{- \frac{{\left‖{x}_{i} - {x}_{j}\right‖}^{2}}{t}}$$

for points of Gᵢⱼ =1 in the matrix, (t is a suitable constant), a thereby obtained matrix is a weight matrix S of the training set, where

$${S}_{\text{ij}} = {e}^{- \frac{{\left‖{x}_{i} - {x}_{j}\right‖}^{2}}{t}}$$

Further, a formula for calculating the Laplace scores is as following:

$${L}_{r} = \frac{\sum {}_{i j} {\left({f}_{r i} - {f}_{r j}\right)}^{2} {S}_{i j}}{V a r \left({f}_{r}\right)}$$

where Lᵣ is a Laplace score for an r-th feature,
fᵣᵢ - fᵣⱼ is a difference of the r-th features of an i-th sample and a j-th sample,
Sᵢⱼ is a corresponding value in the weight matrix, and
Var(fᵣ) is a variance of the r-th feature to all samples.

Thus, each feature will be given a score, and eventually the k features with the highest scores are taken as an eventually selected feature subset. The importance of each flood impact factor on the assessment results can be intuitively seen by using the Laplacian score method, and the operators can directly prevent the impact factors that have a higher degree of impact on the results after the overall flood hazard assessment is conducted, which greatly reduces the difficulty in operation compared with traditional manual determination.

In Step four, a LightGBM model of the ensemble learning is trained by using the new training set in Step three, and accuracy rates of the LightGBM model of the ensemble learning for the new training set and the new testing set are obtained. LightGBM (Lightweight Gradient Boosting Tree) is a method for improving an ensemble learning based on the traditional machine learning model GBDT (Gradient Descent Tree), which effectively reduces the complexity of the algorithm operation, which mainly adopts the GOSS (unilateral gradient sampling) method to calculate the gradient according to the sample sampling results, compared with the traditional ensemble learning method. For samples with larger gradients, all samples are retained by GOSS, whereas for samples with smaller gradients, the samples are randomly sampled by GOSS. A main process of the adopted GOSS algorithm is as follows.

First, a decision tree learning is used to obtain a function that maps the input space to a gradient space in GOSS algorithm. Assuming that the feature subset obtained by using the Laplacian score method in Step three has a total of n instances, a feature dimension is s, each time a gradient iteration is performed, a negative gradient direction of a loss function in the LightGBM model is expressed as g1,..., gn , and the decision tree divides the sample data into each leaf node through an optimal split point (maximum information gain point), and the split point d of feature j is defined as:

$${V}_{j \vert {O}^{\left(d\right)} = \frac{1}{{n}_{O}}} \left(\frac{{\left(\sum {}_{{\left\{{x}_{i} ∈ O : {x}_{i j} \leq d\right\}}^{g {}_{i}}}\right)}^{2}}{{n}_{l \vert O}^{j} \left(d\right)} + \frac{{\left(\sum {}_{{\left\{{x}_{i} ∈ O : {x}_{i j} \leq d\right\}}^{g {}_{i}}}\right)}^{2}}{{n}_{r \vert O}^{j} \left(d\right)}\right)$$

where

$${n}_{O} = \sum I \left[{x}_{i} ∈ O\right] , {n}_{l \vert O}^{j} = \sum I \left[{x}_{i} ∈ O : {x}_{i} \geq d\right] , {n}_{r \vert O}^{j} = \sum I \left[{x}_{i} ∈ O : {x}_{i} > d\right] ,$$

O represents the training set of a fixed node.

Then, the GOSS sorts in a descending order according to a gradient training, and retains top sample instances with a number of a as a data subset of A. For the remaining small gradient samples, data of size b are randomly sampled as a data subset of B, and then the data subset of A and the data subset of B are combined.

Eventually, information gains are estimated by Formula (5):

$${\tilde{V}}_{{j}^{\left(d\right)} = \frac{1}{n}} \left(\frac{{\left(\sum {}_{{\left\{{x}_{i} ∈ A : {x}_{i j} \leq d\right\}}^{g {}_{i}}} + \frac{1 - a}{b} \sum {}_{{\left\{{x}_{i} ∈ A : {x}_{i j} \leq d\right\}}^{g {}_{i}}}\right)}^{2}}{{n}^{j} l \left(d\right)} + \frac{{\left(\sum {}_{{\left\{{x}_{i} ∈ A : {x}_{i j} > d\right\}}^{g {}_{i}}} \frac{1 - a}{b} \sum {}_{{\left\{{x}_{i} ∈ B : {x}_{i j} \leq d\right\}}^{g {}_{i}}}\right)}^{2}}{{n}_{r}^{j} \left(d\right)}\right)$$

After one time of the GOSS calculation, a weak classifier is trained; then the GOSS algorithm is repeated to train multiple weak classifiers until Formula (5) is converged or the number of iteration steps is reached, and eventually, the information gains of all of the trained weak classifiers are added to obtain an eventual ensemble learning model, and to obtain the accuracy rates of the LightGBM model of the ensemble learning for the new training set and the new testing set.

In Step five, the trained model is utilized to calculate the whole basin, and to obtain a probability value of for the hazard on the flood sensitivity in the whole basin. For a visual interpretation on the flood-susceptible locations, the probability map needs to be classified into different regions. For classification, there are various methods in the research, such as equal interval, quantile, standard deviation. The optimal output is generally obtained by using the quantile method for the flood basin, thereby obtaining the flood hazard sensitivity map. Research regions for a flood disaster hazard are classified into five grades: a lower hazard region, a less lower hazard region, a medium hazard region, a higher hazard region and an extremely higher hazard region.

In order to verify the feasibility of the method in the present disclosure, Sanmenxia to Huayuankou in the Yellow River Basin is selected as the research region, and the MODIS remote sensing images are obtained by using the historical flood data recorded in hydrology books, thereby obtaining the maximum inundation range of the research region, and randomly sampling from the maximum inundation range. A total of 300 inundation sample points and 300 non-inundation sample points are selected in the research region, of which 70% are taken as the training sets and 30% are taken as the testing sets. In the research region, a total of 10 flood impact factors including elevation, gradient, slope direction, curvature, SPI, TWI, distance from the river, soil, vegetation and rainfall, are selected and the Laplace score for each flood impact factor is calculated respectively, and the calculation results are as shown in Table 1.

During the training of the model, LightGBM and XGBoost that is the mainstream ensemble learning method on the market are selected to conduct a comparative test in the present disclosure. After the comparative test, it is found that the accuracy rate of XGBoost is 80.97%, whereas the accuracy rate of LightGBM is 81.29%, and the operation speed of LightGBM is much higher than that of XGBoost.

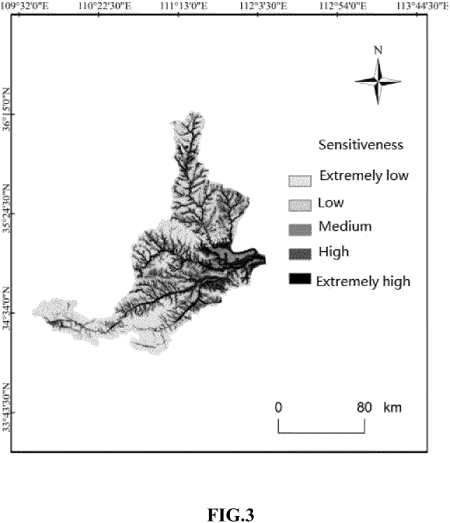

The data in the research region are input into the LightGBM model to generate a probability map of flood sensitivity, and the probability map is divided into five grades by using the quantile method, including an extremely higher hazard, a higher hazard, a medium hazard, a lower hazard and an extremely lower hazard. The results are as illustrated in FIG. 3.

TABLE 1

| Impact factors | Elevation | Gradient | Slope direction | Curvature | SPI | TWI | Distance from river | Soil | Vegetation | Rainfall |
|---|---|---|---|---|---|---|---|---|---|---|
| Scores | 0.987 | 0.985 | 0.991 | 1.000 | 1.032 | 1.012 | 0.985 | 0.903 | 0.995 | 1.001 |

What is claimed is:

1. A method for assessing a hazard on flood sensitivity based on an ensemble learning, wherein the method comprises following steps:
Step one, collecting and sorting initial data of sample points: drawing a position map of a flood in a basin by using literature materials and surveying on site, and creating a spatial database related to the flood; selecting regulating factors through data obtained from the literature materials and the survey on site; selecting a plurality of flood regulating factors to conduct a sensitivity analysis, and establishing a spatial database of the factors;
Step two, cleaning and standardizing the collected initial data, assigning the initial data to each evaluation unit, converting the initial data into a raster data storage format, and performing a projection conversion and a resampling operation on all of the data; acquiring, for each research region, historical flow data from a corresponding hydrological station, retrieving a date for each year, on which a flood flow crest value occurs, and selecting MODIS images corresponding to the date to reflect an inundation status during the flood; superimposing inundation ranges reflected by the plurality of images corresponding to the flow crest value to generate a combined maximum inundation range map as an inundation range map, namely a maximum inundation range, corresponding to the flow crest value; randomly selecting N flood inundation sample points within the maximum inundation range, and randomly selecting N non-flood inundation sample points within a non-maximum flood inundation range to form sample points with a total number of 2N together; dividing the sample points into a training set and a testing set, wherein 70% of the sample points are taken as the training set, and 30% of the sample points are taken as the testing set;
Step three, calculating Laplace scores to determine eventual feature subsets: scoring, by using the Laplace scores, features of the samples in the training set in Step two to obtain a score for each feature, and eventually taking k features with highest scores as selected feature subsets; extracting the feature subsets from the sample points with the total number of 2N in Step two to form a new training set and a new testing set;
Step four, training, by using the new training set in Step three, a LightGBM model of the ensemble learning, and obtaining accuracy rates of the LightGBM model of the ensemble learning for the new training set and the new testing set; and
Step five, calculating, by using the trained model, for the whole basin to obtain a probability value for the hazard on the flood sensitivity in the whole basin;
wherein the plurality of flood regulating factors in Step one include: atmosphere, evaporation, topography, and river networks; 10 indicators, namely features, for assessing the hazard on the flood sensitivity, including elevations, gradients, curvatures, TWI, SPI, distances from rivers, soil, vegetation, slope directions and rainfalls are proposable from the 4 factors; according to a mechanism of the flood in the basin, the factors are calculated and processed based on an ArcGIS software, and the SPI and the TWI are calculated by using following formulas:
$$\text{TWI} = L n \left(α / tan \text{} β\right)$$
$$\text{SPI} = {A}_{s} tan β$$
wherein α represents a cumulative slope water discharge through one point, Aₛ represents a specific basin area, and tan β represents a gradient angle at the point.

2. The method for assessing the hazard on the flood sensitivity based on the ensemble learning according to claim 1, wherein the standardizing process on the initial data in Step two comprises:
conducting data cleaning on a sample data set S to remove corrupt and unnecessary data to conduct a correlation verification; and
classifying all scale condition factors by using a popular quantile method; converting, after preparing the data set, each condition factor into a grid spatial database with a size of m*n, and constructing a grid map for the basin region.

3. The method for assessing the hazard on the flood sensitivity based on the ensemble learning according to claim 1, wherein the process of calculating the Laplace scores to determine the eventual feature subsets in Step three comprises:
constructing an adjacency matrix G for the samples in the training set in Step two: when type (i)=type (j), then Gᵢⱼ =1, otherwise Gᵢⱼ =0, and then letting
$${G}_{\text{ij}} = {e}^{- \frac{{\left‖{x}_{i} - {x}_{j}\right‖}^{2}}{t}}$$
for points of Gᵢⱼ =1 in the matrix, where t is a suitable constant;
a thereby obtained matrix being a weight matrix S of the training set, where
$${S}_{\text{ij}} = {e}^{- \frac{{\left‖{x}_{i} - {x}_{j}\right‖}^{2}}{t}}$$
; and
a formula for calculating the Laplace scores being:
$${L}_{r} = \frac{{\sum {}_{i j} \left({f}_{r i} - {f}_{r i}\right)}^{2} {S}_{i j}}{V a r \left({f}_{r}\right)}$$
where Lᵣ is a Laplace score for an r-th feature; fᵣᵢ - fᵣⱼ is a difference of r-th features of an i-th sample and a j-th sample; Sᵢⱼ is a corresponding value in the weight matrix; and Var(fᵣ) is a variance of the r-th feature to all samples.

4. The method for assessing the hazard on the flood sensitivity based on the ensemble learning according to claim 1, wherein in Step five, research regions for a flood disaster hazard are divided into five grades: a lower hazard region, a less lower hazard region, a medium hazard region, a higher hazard region and an extremely higher hazard region.
